(19) United States
(12) Patent Application Publication
(10) Pub. No.: US 2009/0002699 A1
(43) Pub. Date: Jan. 1, 2009

(54) METHOD AND DEVICE FOR IDENTIFYING AN UNKNOWN SUBSTANCE

(76) Inventors: William Scott Sutherland, Haverhill, MA (US); Yuan-Hsiang Lee, Winchester, MA (US); Patrick Ronald Engel, Watertown, MA (US); Ruben Fernando Salinas, Duluth, GA (US)

Correspondence Address: PATRICK W. RASCHE (22697);ARMSTRONG TEASDALE LLP, ONE METROPOLITAN SQUARE, SUITE 2600, ST. LOUIS, MO, 63102-2740, US

(21) Appl. No.: 11/769,920

(22) Filed: Jun. 28, 2007

(51) Int. Cl. G01J 3/44; G01J 3/30

(52) U.S. Cl. 356/301; 356/318

(57) ABSTRACT

A device for identifying an unknown substance includes an optical source configured to direct a laser excitation beam at the unknown substance. A detector is configured to detect scattered light from the unknown substance and generate at least one signal representative of a scattering spectrum corresponding to at least one chemical within the unknown substance. A microprocessor is in signal communication with the detector and configured to generate a pattern representative of the at least one chemical in response to the at least one signal received from the detector to identify the chemical composition of the unknown substance. The device is configured to complete a bioassay to identify a biological nature of the unknown substance.

### BACKGROUND OF THE INVENTION

This invention relates generally to devices utilized to perform chemical and biological assays and, more particularly, to an integrated device that is configured to perform a chemical assay to identify a chemical composition and/or a biological assay to identify a biological nature or identity of an unknown substance.

First responders often encounter a wide variety of unknown substances that must be assessed using a variety of devices to determine whether each unknown substance is a chemical threat, a biological threat, or not a threat. To analyze and identify target substances, first responders often utilize a variety of devices or instruments to assess the nature of each specific substance that they may encounter on a daily basis. For example, first responders currently use a first device to detect and identify chemical threats and a second device to detect and identify biological threats.

As such, each first responder, or group of first responders, is typically provided with a variety of devices to allow the first responder to properly identify a variety of target substances. As a result, the cost of providing the separate devices required to identify both chemical and biological substances may be prohibitively expensive for smaller communities. Moreover, the first responders must also carry the variety of devices to the scene being investigated along with other equipment utilized by the first responders, thus increasing the time and energy required to screen large facilities for unidentified substances.

### BRIEF DESCRIPTION OF THE INVENTION

In one aspect, a device for identifying an unknown substance is provided. The device includes an optical source configured to direct a laser excitation beam at the unknown substance. A detector is configured to detect scattered light from the unknown substance and generate at least one signal representative of a scattering spectrum corresponding to at least one chemical within the unknown substance. A microprocessor is in signal communication with the detector and configured to generate a pattern representative of the at least one chemical in response to the at least one signal received from the detector to identify the chemical composition of the unknown substance. The device is configured to complete a bioassay to identify a biological nature of the unknown substance.

In another aspect, a device for identifying an unknown substance is provided. The device includes an optical source configured to direct a laser excitation beam at the unknown substance. A detector is configured to detect scattered light from the unknown substance and generate at least one signal representative of at least one Raman spectrum corresponding to a chemical within the unknown substance. A microprocessor in signal communication with the detector is configured to process the at least one signal to facilitate identifying the chemical corresponding to the at least one Raman spectrum. A bioassay assembly is operatively coupled to the microprocessor. The bioassay assembly is configured to facilitate completing a bioassay to identify a biological nature of the unknown substance.

In a further aspect, a method is provided for identifying an unknown substance using an integrated device. The method includes directing a laser excitation beam from an optical source at the unknown substance. Scattered light from the unknown substance is detected and at least one signal representative of a scattering spectrum corresponding to at least one chemical within the unknown substance is generated. The at least one signal is processed with a microprocessor housed within the device to generate a pattern representative of the at least one chemical. The at least one chemical within the unknown substance is then identified. A bioassay is completed to facilitate identifying a biological nature of the unknown substance.

### BRIEF DESCRIPTION OF THE DRAWINGS

FIG. 1 is a perspective view of a device that is configured to analyze a chemical composition and/or a biological nature or identity of a substance or material.

FIG. 2 is a rear view of the device shown in FIG. 1.

FIG. 3 is a schematic view of an exemplary electronic configuration for the device shown in FIG. 1.

FIG. 4 is a perspective view of an exemplary bioassay assembly including an assay cartridge suitable for use in cooperation with the device shown in FIG. 1.

FIG. 5 is a perspective view of the bioassay assembly coupled to the device.

FIG. 6 is a schematic view of a portion of the assay compartment shown in FIG. 4, and containing nanotags and magnetic separation beads.

FIG. 7 is an exemplary alternative bioassay assembly including a lateral flow device having an assay cartridge and suitable for use in cooperation with the device shown in FIG. 1.

FIG. 8A is a schematic view of a substrate of the lateral flow device shown in FIG. 7.

FIG. 8B is a schematic view of a substrate of the lateral flow device shown in FIG. 7.

FIG. 8C is a schematic view of a substrate of the lateral flow device shown in FIG. 7.

### DETAILED DESCRIPTION OF THE INVENTION

The present invention provides an integrated, handheld device or instrument to facilitate assessing a chemical composition and/or a biological nature or identity of an unknown substance, or a sample portion of the unknown substance, to identify potential chemical threats and/or potential biological threats. The substances may be contained within a sealed container, within a transparent or translucent container or the substances may be coated with a material layer. In one embodiment, the device utilizes Raman spectroscopy to facilitate identifying the chemical composition and/or the biological nature or identity of the unknown substance. The device utilizes a laser excitation beam at a suitable wavelength, such as about 1 micron, to provide high resolution sample identification while eliminating or reducing sample fluorescence. The device is further capable of pre-screening a sample of the unknown substance to identify a potential biological threat. Upon identification of a potential biological threat, the device facilitates determining whether the biological substance is a real biological threat, such as a spore, virus or toxin, by employing an assay including Raman-active or surface-enhanced Raman (SERS) nanotags and utilizing the device platform for collecting the Raman spectra for chemical composition identification. Thus, the device provides a high quality chemical assay incorporating an orthogonal technology, such as Raman spectroscopy, to facilitate identifying the chemical composition of the unknown substance and a complete bioassay to facilitate identifying a biological nature or identity of the unknown substance. In a particular embodiment, the device is configured to facilitate screening the unknown substance to identify a protein-based biological substance within the unknown substance and complete the bioassay.

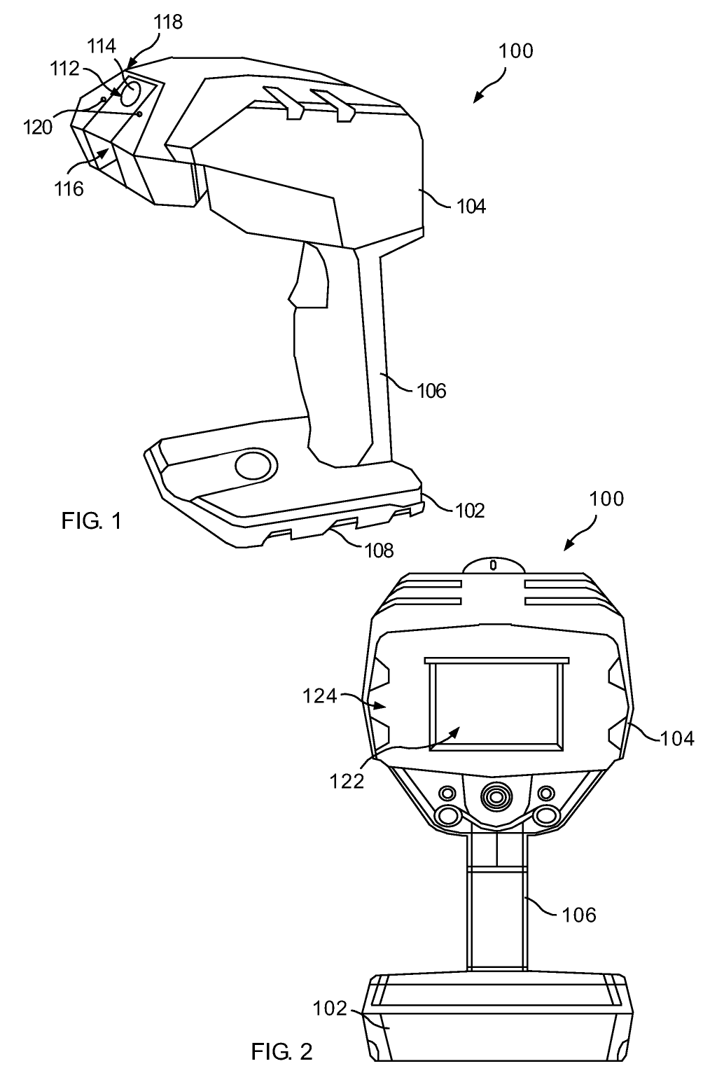

FIG. 1 is a perspective view of a device 100 configured to assess the chemical composition and/or the biological nature or identity of an unknown substance or material to facilitate identifying potential chemical threats and/or potential biological threats. FIG. 2 is a rear view of device 100. In the exemplary embodiment, device 100 is an integrated, handheld device including a Raman spectroscopy system having a suitable spectroscopy engine. In a particular embodiment, the spectroscopy system includes a Raman spectrometer technology, such as the STREETLAB portable substance identification system available from GE Security, Inc., located in Wilmington, Mass., USA. It should be apparent to those skilled in the art and guided by the teachings herein provided that device 100 may include any suitable spectroscopy system.

In the exemplary embodiment, device 100 includes a base 102, a head 104 and a handle 106 extending between base 102 and head 104. Base 102 includes a substantially planar bottom surface 108 that enables device 100 to stand substantially upright on a surface, as shown in FIG. 1. Device 100 is capable of being stored and/or operated in any suitable position or configuration, such as described below.

In the exemplary embodiment, an optical source 112 is positioned at or within head 104. Optical source 112 is configured to generate a beam of light, such as a laser excitation beam, and direct the laser excitation beam at or toward the unknown substance. In the exemplary embodiment, device 100 includes a Raman spectrometer that directs the laser excitation beam at the unknown substance such that photons interact with vibrationally excited molecules of the unknown substance resulting in a change in radiation, i.e., an increase or decrease in photon energy. Raman scattering includes inelastic scattering of photons upon interaction with the substance molecules to produce one or more Raman spectra. When detected and processed by device 100, each unique Raman spectrum is compared to Raman spectra stored within device 100 for known chemicals or known chemical compositions to facilitate identifying the chemical composition of the unknown substance. In a particular embodiment, optical source 112 includes a probe 114 positioned on a first or front surface 116 of head 104. Probe 114 is positionable in contact proximity with the unknown substance. As used herein, references to “contact proximity” are to be understood to refer to positioning probe 114 to contact the unknown substance or to contact an outer surface of a container in which the unknown substance is contained, for example.

As shown in FIG. 1, in the exemplary embodiment, a coupling mechanism 118 is coupled to front surface 116 and with respect to optical source 112. Coupling mechanism 118 defines at least one void 120 configured to receive and retain at least a portion of an assay cartridge with respect to optical source 112 for completing a bioassay to facilitate identifying unknown biological substances, as described in greater detail below. In alternative embodiments, device 100 includes any suitable coupling mechanism 118 for coupling an assay cartridge to device 100.

As shown in FIG. 2, a display 122 is positioned within a second or rear surface 124 of head 104. In the exemplary embodiment, display 122 includes a LCD display. In alternative embodiments, display 122 includes any suitable display for displaying data including, without limitation, information regarding device 100 and/or the unknown substance.

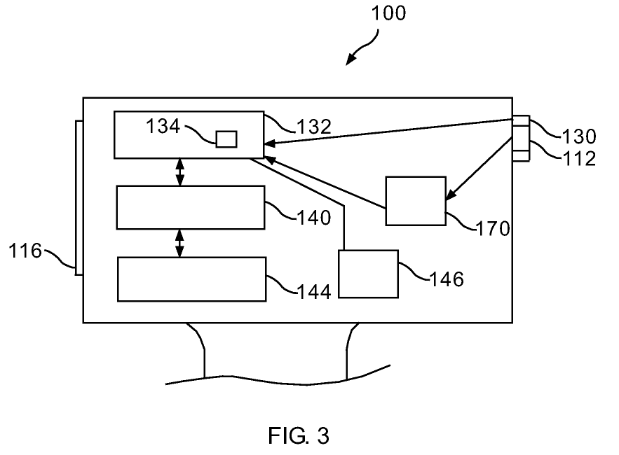

FIG. 3 is a schematic view of an exemplary electronic configuration for device 100. Optical source 112 is configured to direct the laser excitation beam at the unknown substance. A detector 130 is configured to detect scattered light from the unknown substance resulting from the interaction of laser excitation beam photons with molecules of the unknown substance. Detector 130 generates one or more signals representative of at least one scattering spectrum, such as at least one Raman spectrum, each corresponding to a specific chemical within the unknown substance. In the exemplary embodiment, the unknown substance may have a chemical composition including one or more chemicals. If more than one chemical is present in the unknown substance, the generated signals will transmit data corresponding to a Raman spectrum for each chemical present in the unknown substance.

Referring further to FIG. 3, the signals are transmitted from detector 130 to a microprocessor 132 in signal communication with detector 130. In response to the received signals, microprocessor 132 is configured to generate at least one pattern, such as at least one Raman spectrum, representative of the one or more chemicals present in the unknown substance. In the exemplary embodiment, software 134 is embedded within microprocessor 132 to analyze the signals representing the scattering spectra. In a particular embodiment, software 134 locates and/or identifies peaks in each scattering spectrum. Software 134 is capable of identifying one or more peaks in any suitable number of spectra such that multiple chemicals within the unknown substance may be identified by analyzing the peaks in the corresponding spectrum. In one embodiment, the identified peaks of each spectrum are compared to a plurality of scattering spectra for known chemicals stored within device 100. In the exemplary embodiment, the scattering spectra for known chemicals are stored within an integrated data storage memory 140 operative coupled to microprocessor 132 to facilitate matching each generated spectrum to a stored spectrum. In a particular embodiment, data storage memory 140 includes a suitable memory or electronic storage for facilitating comparing the generated pattern or spectrum with a plurality of patterns or spectra for known chemicals stored within the memory or electronic storage. The matching spectrum is indicative of a known chemical and, thus, at least partially identifies the chemical composition of the unknown substance. In an alternative embodiment, the spectrum representing a chemical within the unknown substance is analyzed using any suitable method known to those skilled in the art and guided by the teachings herein provided. In a particular alternative embodiment, the spectrum is processed and/or analyzed without the use of microprocessor 132, software 134 and/or data storage memory 140.

Data including, without limitation, the identification of the chemical or chemicals within the unknown substance is output to the operator. In the exemplary embodiment, the data is visually displayed on display 122. In an alternative embodiment, the data is printed on a printout or communicated to local and/or remote operators using any suitable communication device. In a particular embodiment, the data is transmitted by wireless transmitter/receiver 144 to a remote terminal or location, such as a remote computer. In alternative embodiments, the data is transmitted to a remote location using any suitable transmission device. Device 100 also includes a suitable battery and power management system 146.

In the exemplary embodiment, the electronic components are integrated with and/or housed within device 100 to provide a handheld, portable device 100. However, it should be apparent to those skilled in the art and guided by the teachings herein provided that, in alternative embodiments, one or more electronic components of device 100 may be positioned externally to device 100.

Further, device 100 is configured to complete a bioassay to identify a biological nature or identity of the unknown substance. In a particular embodiment, device 100 completes the bioassay upon detecting that the unknown substance includes one or more protein-based biological substances. In the exemplary embodiment, a bioassay assembly 150 is operatively coupled to microprocessor 132. Bioassay assembly 150 is configured to complete the bioassay to facilitate identifying the biological nature of the unknown substance based on at least one Raman spectrum. Bioassay assembly 150 is configured to identify a biological nature of multiple biological substances within a sample of the unknown substance using a single test. Thus, device 100 is capable of multiplexing.

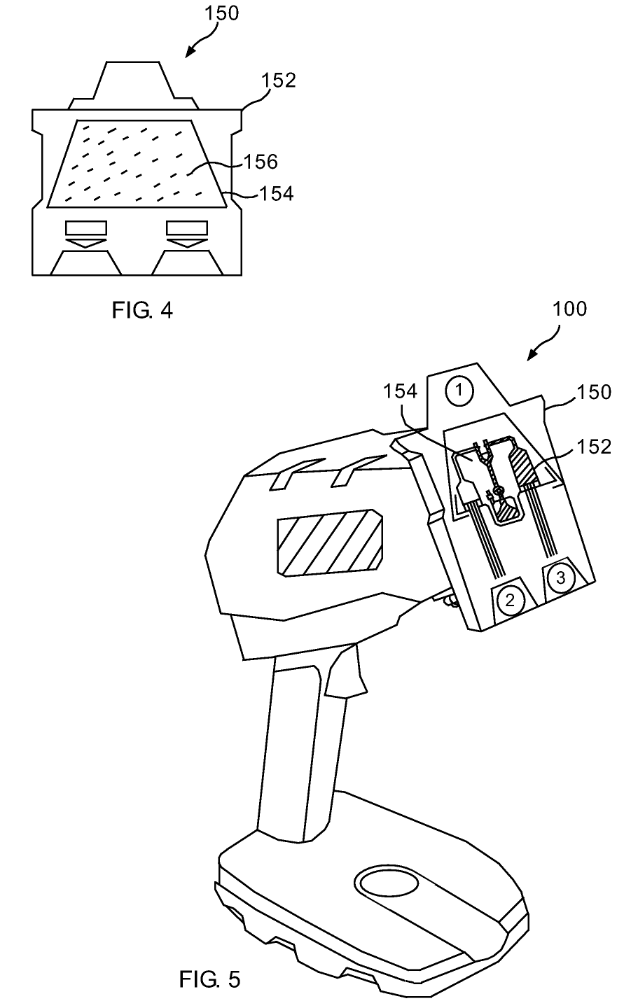

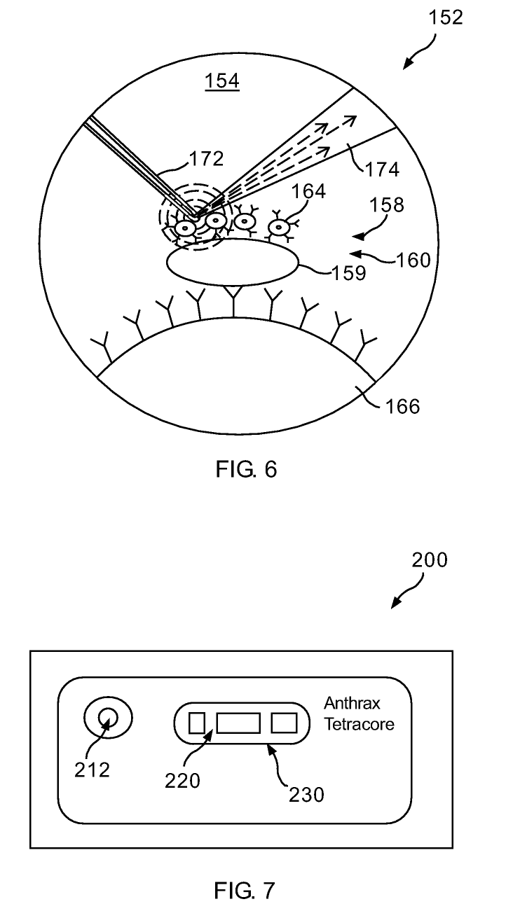

FIG. 4 is a perspective view of an exemplary bioassay assembly 150 including an assay cartridge 152 suitable for use with device 100 to complete a bioassay of the unknown substance. FIG. 5 is a perspective view of bioassay assembly 150 coupled to device 100. FIG. 6 is a schematic view of a portion of assay compartment 152 containing nanotags and magnetic separation beads for completing a bioassay. A bioassay as used herein is defined as a quantitative or qualitative test of an unknown substance to determine its composition and/or components. Bioassay assembly 150 may be utilized in cooperation with device 100 to identify a biological nature or identity of an unknown substance including biological substances.

Referring further to FIGS. 4 and 5, assay cartridge 152 is positionable in communication with optical source 112. As described above, in one embodiment at least a portion of assay cartridge 152 is positioned within voids 120 defined within head 104 such that coupling mechanism 114 retains assay cartridge 152 in communication with optical source 112. Assay cartridge 152 defines a compartment 154 configured to receive a sample portion 156 of the unknown substance. Sample portion 156 is transferred into compartment 154 using any suitable mechanism, such as a scoop or spoon (not shown). In the exemplary embodiment, a suitable liquid is contained within compartment 154 and sample portion 156 is dispersed within the liquid to form a solution.

As shown in FIG. 6, one or more reagents 158 are introduced into compartment 154. Reagents 158 are configured to selectively interact with a target biological substance 159, such as anthrax, within sample portion 156 to form a complex 160. In the exemplary embodiment, reagent 158 includes one or more nanotags, such as Raman-active or surface-enhanced Raman (SERS) nanotags 164 shown in FIG. 6, that include an antibody against the target biological substance and one or more magnetic separation beads 166 also including the antibody. In a particular embodiment, each SERS nanotag 164 includes a gold core coated with or including one or more Raman reporter molecules configured to generate a SERS signal. A glass shell encapsulates or surrounds the gold core and the Raman reporter molecules. An antibody label against the target biological substance is coupled to an outer surface of the glass shell. In alternative embodiments, SERS nanotags 164 may include a particle configured to generate an enhanced Raman spectrum and a tag coupled to the particle.

In the exemplary embodiment, only one type of antibody is coupled to or covers at least a portion of the outer surface of the glass shell. As a result, SERS nanotags 164 interact with and couple to one specific target biological substance to facilitate identifying the biological nature or identity of the unknown substance. In an alternative embodiment, one or more SERS nanotags 164 are covered with a different antibody and are configured to interact with and adhere to a different target biological substance to facilitate identifying multiple biological substances within the unknown substance. In one embodiment, SERS nanotags 164 are configured to interact with and adhere to commonly discovered target biological substances including, without limitation, CDC category A, B and C substances such as anthrax and small pox.

Similarly, magnetic separation beads 166 are also at least partially covered with or coupled to an antibody that is configured to adhere to a target biological substance. In the exemplary embodiment, only one type of antibody is coupled to magnetic separation beads 166 to interact with and couple to one specific target biological substance. In an alternative embodiment, one or more magnetic separation beads 166 are covered with a different antibody and are configured to interact with and adhere to a different target biological substance including, without limitation, CDC category A, B and C substances such as anthrax and small pox.

In the exemplary embodiment, a magnetic source (not shown) generates a magnetic field with respect to assay cartridge 152, such as at or near compartment 154, to facilitate collecting complex 160 in a localized region within compartment 154. Complex 160 includes the target biological substance attached to SERS nanotags 164 and magnetic separation beads 166 as a result of the selective interaction between the target biological substance and the antibody coupled to SERS nanotags 164 and magnetic separation beads 166.

A reader 170 is in signal communication with optical source 112 and configured to detect scattered light from complex 160. In the exemplary embodiment, reader 170 is an independent electronic component operatively coupled to and in signal communication with microprocessor 132. In alternative embodiments, reader 170 may be integrated with or contained within detector 130. Reader 170 generates one or more signals representative of at least one scattering spectrum, such as at least one Raman spectrum, corresponding to complex 160 that are transmitted to microprocessor 132 for processing. Microprocessor 132 processes the signals to determine and/or confirm the identification of each biological substance within the unknown substance. In one embodiment, SERS nanotags 164 are specific to one target biological substance. Microprocessor 132 is configured to process a Raman spectrum produced by SERS nanotags 164 to facilitate identifying the biological substance.

During operation, device 100 identifies the chemical composition of the unknown substance and/or, upon detection of a biological substance within the unknown substance, the biological nature or identity of the unknown substance. An unknown substance suspected of being a chemical threat or biological threat is identified by positioning optical source 112 substantially in contact with the unknown substance. More specifically, in one embodiment, probe 114 is positioned in contact proximity with the unknown substance or a container containing the unknown substance. In alternative embodiments, optical source 112 is positioned adjacent the unknown substance or adjacent a container containing the unknown substance.

In the exemplary embodiment, an operator grips device 100 at handle 106 and positions optical source 112 substantially in contact with the unknown substance. In an alternative embodiment, the operator places device 100 in an upright position, such as shown in FIG. 1, on a suitable surface such that device 100 is resting on bottom surface 108 and optical source 112 is substantially in contact with the unknown substance. In further alternative embodiments, device 100 is placed in a face-down position or any suitable position with optical source 112 substantially in contact with the unknown substance. With device 100 in a suitable operating position, device 100 may be remotely operable, as described below.

After positioning optical source 112 substantially in contact with the unknown substance, device 100 is activated. In the exemplary embodiment, device 100 is activated by operating any suitable activation mechanism including, without limitation, a trigger, a button, a switch or a touch screen button on display 116. In an alternative embodiment, device 100 is remotely activated by a signal transmitted to wireless transmitter/receiver 144 or using any suitable remote activation device. In this embodiment, device 100 is remotely activated when an operator, due to unsafe conditions, exits the site of the unknown substance after positioning device 100 with optical source 112 substantially in contact with the unknown substance.

Upon activation of device 100, optical source 112 directs a laser excitation beam at the unknown substance. Excitation of the unknown substance produces at least one scattering spectrum that is detected by detector 130. When identifying a chemical composition of the unknown substance, excitation by the laser excitation beam of covalent bonds in the chemical composition produces one or more scattering spectra depending upon the number of chemicals within the unknown substance. Each chemical within the unknown substance produces a unique scattering spectrum and, as such, each chemical is identifiable by its unique scattering spectrum. Detector 130 detects the scattered light from the unknown substance and generates one or more signals representative of a scattering spectrum corresponding to one or more chemicals within the unknown substance.

The generated signals containing data corresponding to a Raman spectrum of each chemical within the unknown substance are transmitted to microprocessor 132. Microprocessor 132 is configured to process the signals received from detector 130 to generate a pattern, such as a Raman spectrum, representative of each chemical to facilitate identifying each chemical within the unknown substance. In one embodiment, software 134 is utilized to facilitate identifying each chemical represented by the generated patterns. The generated patterns are each compared with a plurality of patterns for known chemicals stored within a memory or electronic storage to identify the chemical composition of the unknown substance. The generated patterns are compared with the stored patterns using any suitable software algorithm known to those skilled in the art and guided by the teachings herein provided.

In the exemplary embodiment, a bioassay is completed to facilitate identifying the biological nature or identity of the unknown substance. A sample portion of the unknown substance is dispersed within assay cartridge compartment 154. In one embodiment, a suitable liquid is contained within compartment 154 such that the sample portion is dispersed throughout the liquid to form a solution. At least one reagent 158 is introduced into the solution using a suitable transfer mechanism, such as a scoop or spoon. Reagents 158 are configured to selectively interact with and adhere to a target biological substance. Reagents 158 adhere or attach to the target biological substance to form complex 160, which is then separated from the solution using a suitable technique, such as described herein.

In one embodiment, SERS nanotags 164 including an antibody against the target biological substance and magnetic separation beads 166 including the antibody against the target biological substance are introduced into the solution. For example, if the unknown substance is suspected of including anthrax, SERS nanotags 164 covered with an anthrax antibody and magnetic separation beads 166 also covered with an anthrax antibody are placed in compartment 154 with the unknown substance sample portion. It should be apparent to those skilled in the art and guided by the teachings herein provided that SERS nanotags 164 and magnetic separation beads 166 may include any chemically and/or biologically selective material or substance including, without limitation, a suitable antibody or aptamer, against any suitable target biological substance in alternative embodiments.

The solution is allowed to react with reagents 158 introduced into compartment 154 for a period of time. In one embodiment, the solution is also agitated with heat and/or motion. If the biological substance within compartment 154 is not the target biological substance, such as anthrax, no reaction takes place between the unknown biological substance and the antibody coupled to SERS nanotags 164 and magnetic separation beads 166. However, if the unknown biological substance is anthrax, the antibody reacts with the anthrax causing SERS nanotags 164 and magnetic separation beads 166 to adhere to the anthrax to form at least one pellet or complex 160. The antibody interacts with and adheres to the target biological substance to form complex 160 including the target biological substance attached to SERS nanotags 164 and magnetic separation beads 166.

Complex 160 is then collected in a localized region within compartment 154. In the exemplary embodiment, after allowing time for the formation of complex 160, a magnetic source is placed against cartridge 152, such as with respect to compartment 154. The magnetic source generates a magnetic field having sufficient strength to urge complex 160 to separate from the remainder of the solution and draw complex 160 toward the magnetic source. More specifically, the magnetic field draws magnetic separation beads 166 toward the magnetic source. Because at least some magnetic separation beads 166 have bonded to the target biological substance to form complex 160, complex 160 is magnetically drawn to the localized region within compartment 154.

Cartridge 152 is then coupled to device 100 such that compartment 154 is in communication with optical source 112. In a particular embodiment, probe 114 is in contact proximity with the outer surface of compartment 154 such that complex 160 formed in compartment 154 is magnetically drawn to the portion of compartment 154 positioned in contact proximity with probe 114.

Complex 160 is scanned with optical source 112 to facilitate completing the bioassay. Device 100 is activated and optical source 112 directs a laser excitation beam 172 at complex 160 to facilitate determining whether any SERS nanotags 164 are present in complex 160. In one embodiment, scattered light 174 from complex 160 is detected by reader 170. If complex 160 does not include SERS nanotags 164, reader 170 generates a zero signal. If complex 160 includes SERS nanotags 164, reader 170 generates a signal representative of a Raman spectrum for the Raman reporter molecule contained within SERS nanotags 164. The signal indicates that the target biological substance is present in the solution and, thus, identifies the biological nature or identity of the unknown substance. The generated signals are transmitted to microprocessor 132 for processing and analysis. The Raman spectrum represented by the signals is compared with a plurality of Raman spectra stored within microprocessor 132, such as within a suitable memory or electronic storage, for known biological substances to identify or confirm that the unknown substance includes the target biological substance. In the exemplary embodiment, a signal is transmitted to display 116 to display data including information regarding the biological nature or identity of the unknown substance. Further, if the target biological substance is not present within complex 160, the above-described steps can be repeated as necessary using SERS nanotags 164 and magnetic separation beads 166 configured to detect other target biological substances. Moreover, in a particular embodiment, nanotags 164 and magnetic separation beads 166 including multiple antibodies are introduced substantially simultaneously into compartment 154 to test the unknown substance for multiple target biological substances.

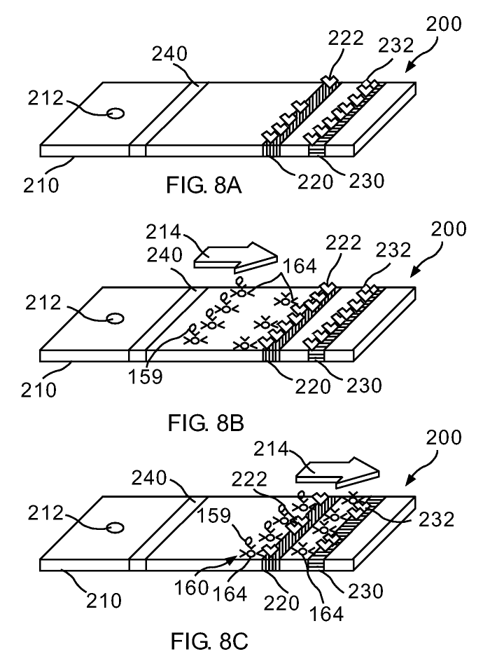

Referring to FIGS. 7 and 8A-8C, in an alternative embodiment, the bioassay assembly includes a lateral flow device 200 that is utilized to complete a bioassay to facilitate identifying the biological nature or identity of the unknown substance. In one embodiment, lateral flow device 200 includes a substrate 210 that is contained within a housing or cartridge 212, such as a plastic housing or cartridge, as shown in FIG. 7. FIGS. 8A-8C schematically show substrate 210 at various stages of a bioassay. In a particular embodiment, substrate 210 is constructed of a nitrocellulose membrane, with several other membrane components having specific functions. In this embodiment, substrate 210 includes one or more sample deposition zones 212. Substrate 210 has one or more flow paths, as indicated by arrow 214 in FIGS. 8B-8C, and one or more detection zones 220. Detection zone 220 is positioned along flow path 214. Detection zone 220 includes one or more immobilized target-binding moieties 222 directed against a target biological substance of a Raman-active complex 160. Lateral flow device 200 also includes one or more control zones 230. Control zone 230 is positioned along flow path 214 down flow from detection zone 220 and includes one or more immobilized particle-binding-moieties 232 directed against a Raman-active nanotag 164.

A sample of the unknown substance is dispersed within a liquid carrier and the bioassay is completed to determine whether a target analyte is present in the unknown substance. With the liquid sample deposited within sample deposition zone 212, the liquid begins to wick across substrate 210 in the direction shown by arrow 214, due to the capillary action and the presence of a contacting adsorbent pad (not shown) positioned at an opposing end of cartridge 202. A contact zone 240 includes a dried but soluble form of SERS nanotags 164, such as shown in FIG. 6. When the liquid sample passes over contact zone 240, SERS nanotags 164 dissolve into the liquid, and attach to target biological substance or analyte 159 if target analyte 159 is present in the liquid sample of the unknown substance. Detection zone 220 includes a capture antibody that is configured to specifically attach to target analyte 159 or target analyte-SERS nanotag complexes 160, such as shown in FIG. 8C. After a suitable time period, such as about a few minutes, when much of the introduced liquid sample has passed by detection zone 220, target analyte-SERS nanotag complexes 160 are immobilized and concentrated onto detection zone 220. In a particular embodiment, optical source 112 is positioned with respect to cartridge 202 to direct a laser excitation beam 172 at detection zone 220 to test the liquid sample containing the unknown substance. The liquid sample containing unbound SERS nanotags 164 continues to flow across substrate 210, and unbound SERS nanotags 164 are collected within control zone 230. The liquid sample present in control zone 230 indicates, in this embodiment, that the liquid sample has successfully wicked across substrate 210, and that the reagents originally present within contact zone 240 were successfully dissolved into the liquid sample. A positive test occurs when SERS nanotags 164 are detected within detection zone 220 and within control zone 230. A negative test is indicated by SERS nanotags 164 present only within control zone 230. An invalid test occurs when no SERS nanotags 164 are present within control zone 230.

The present invention provides an integrated, handheld device or instrument to facilitate assessing a chemical composition and/or a biological nature or identity of an unknown substance or material, or a sample portion of the unknown substance or material, to identify potential chemical threats and/or potential biological threats. The substance or material may be contained within a sealed container, within a transparent or translucent container or the substance or material may be coated with a material layer. In one embodiment, upon identification of a potential biological threat, the device facilitates determining the biological nature or identity of the unknown substance or material, such as a spore, virus or toxin, by employing an assay including Raman-active or surface-enhanced Raman (SERS) nanotags and utilizing the device platform for collecting the Raman spectra for chemical composition identification. Thus, the device provides a high quality chemical assay incorporating an orthogonal technology, such as Raman spectroscopy, to facilitate identifying the chemical composition of the unknown substance or material and a complete bioassay to facilitate identifying the biological nature or identity of the unknown substance or material.

While the invention has been described in terms of various specific embodiments, those skilled in the art will recognize that the invention can be practiced with modification within the spirit and scope of the claims.

What is claimed is:

1. A device for identifying an unknown substance, said device comprising:
an optical source configured to direct a laser excitation beam at the unknown substance;
a detector configured to detect scattered light from the unknown substance and generate at least one signal representative of a scattering spectrum corresponding to at least one chemical within the unknown substance; and
a microprocessor in signal communication with said detector, said microprocessor configured to generate a pattern representative of the at least one chemical in response to said at least one signal received from said detector to identify the chemical composition of the unknown substance, said device configured to complete a bioassay to identify a biological nature of the unknown substance.

2. A device in accordance with claim 1 wherein said optical source further comprises a probe configured to be in contact proximity with the unknown substance.

3. A device in accordance with claim 1 wherein said device utilizes Raman spectroscopy to identify the at least one chemical within the unknown substance.

4. A device in accordance with claim 1 further comprising an integrated data storage memory in communication with said microprocessor, said data storage memory comprising a wavelength and amplitude reference module for facilitating comparing said pattern with a plurality of patterns for known chemicals stored within said wavelength and amplitude reference module.

5. A device in accordance with claim 1 further comprising a bioassay assembly operatively coupled to said microprocessor, said bioassay assembly configured to complete the bioassay to facilitate identifying the biological nature of the unknown substance.

6. A device in accordance with claim 5 wherein said bioassay assembly further comprises:
an assay cartridge positionable in communication with said optical source, said assay cartridge defining a compartment configured to receive a sample portion of the unknown substance;
at least one reagent introduced into said compartment, said at least one reagent configured to selectively interact with a target biological substance within the sample portion to form a complex; and
a reader in signal communication with said optical source, said reader configured to detect scattered light from the complex and generate at least one signal representative of a scattering spectrum corresponding to the complex.

7. A device in accordance with claim 6 wherein said at least one reagent further comprises at least one nanotag including at least one of a chemically and biologically selective material against the target biological substance and at least one magnetic separation bead including the antibody.

8. A device in accordance with claim 7 wherein said device further comprises a magnetic source configured to generate a magnetic field with respect to said assay cartridge to facilitate collecting in a localized region within said compartment the complex comprising the target biological substance attached to said at least one nanotag and said at least one magnetic separation bead.

9. A device in accordance with claim 6 wherein said at least one reagent further comprises a plurality of SERS nanotags, each of said plurality of SERS nanotags comprising a particle configured to generate an enhanced Raman spectrum and a tag coupled to said particle.

10. A device in accordance with claim 9 wherein each said SERS nanotag is specific to one target biological substance, said microprocessor configured to process a scattering spectrum produced by each said SERS nanotag and identify the biological substance.

11. A device for identifying an unknown substance, said device comprising:
an optical source configured to direct a laser excitation beam at the unknown substance;
a detector configured to detect scattered light from the unknown substance and generate at least one signal representative of at least one Raman spectrum corresponding to a chemical within the unknown substance;
a microprocessor in signal communication with said detector, said microprocessor configured to process the at least one signal to facilitate identifying the chemical corresponding to the at least one Raman spectrum; and
a bioassay assembly operatively coupled to said microprocessor, said bioassay assembly configured to facilitate completing a bioassay to identify a biological nature of the unknown substance.

12. A device in accordance with claim 11 wherein said bioassay assembly further comprises:
an assay cartridge positionable in communication with said optical source, said assay cartridge defining a compartment containing a liquid and configured to receive a sample portion of the unknown substance such that the sample portion is dispersed within the liquid;
at least one reagent introduced into the liquid, said at least one reagent configured to selectively interact with a target biological substance within the sample portion to form a complex; and
a reader in signal communication with said optical source, said reader configured to detect scattered light from the complex and generate at least one signal representative of a Raman spectrum corresponding to the complex.

13. A device in accordance with claim 12 wherein said at least one reagent further comprises a plurality of magnetic separation beads including an antibody against the target biological substance, said plurality of magnetic separation beads reactive to a magnetic field generated with respect to said assay cartridge to facilitate forming the complex comprising the target biological substance attached to said plurality of magnetic separation beads.

14. A device in accordance with claim 13 wherein said at least one reagent further comprises a plurality of SERS nanotags, each of said plurality of SERS nanotags comprising:
a gold core;
at least one Raman reporter molecule configured to generate a SERS signal;
a glass shell surrounding said gold core and said at least one Raman reporter molecule; and
an antibody label against the target biological substance coupled to an outer surface of said glass shell, each said SERS nanotag configured to attach to a corresponding target biological substance.

15. A device in accordance with claim 14 further comprising a microprocessor in signal communication with said reader, said microprocessor configured to identify a Raman spectrum produced by each said SERS nanotag corresponding to the target biological substance.

16. A device in accordance with claim 11 wherein said bioassay assembly further comprises a substrate defining a flow path, said substrate comprising a detection zone including at least one immobilized target-binding moiety directed against a target biological substance and a control zone disposed along the flow path down flow from said detection zone, said control zone including at least one immobilized particle-binding-moiety directed against a Raman-active nanotag.

17. A method for identifying an unknown substance using an integrated device, said method comprising:
directing a laser excitation beam from an optical source at the unknown substance;
detecting scattered light from the unknown substance;
generating at least one signal representative of a scattering spectrum corresponding to at least one chemical within the unknown substance;
processing the at least one signal with a microprocessor housed within the device to generate a pattern representative of the at least one chemical;
identifying the at least one chemical within the unknown substance; and
completing a bioassay to facilitate identifying a biological nature of the unknown substance.

18. A method in accordance with claim 17 identifying the at least one chemical within the unknown substance further comprises comparing the pattern with a plurality of patterns for known chemicals stored within a wavelength and amplitude module of the microprocessor.

19. A method in accordance with claim 17 wherein completing a bioassay further comprises:
dispersing a sample portion of the unknown substance within an assay cartridge compartment containing a liquid to form a solution;
introducing at least one reagent into the solution, the at least one reagent configured to selectively interact with a target biological substance;
separating a complex including the target biological substance attached to the at least one reagent from the solution; and
scanning the complex with the optical source.

20. A method in accordance with claim 19 wherein introducing at least one reagent into the assay cartridge compartment further comprises introducing into the solution at least one SERS nanotag including an antibody against the target biological substance and at least one magnetic separation bead including the antibody against the target biological substance, and separating a complex including the target biological substance attached to the at least one reagent from the solution further comprises collecting in a localized region within the assay cartridge compartment the complex comprising the target biological substance attached to the at least one SERS nanotag and the at least one magnetic separation bead.

21. A method in accordance with claim 20 further comprising:
detecting scattered light from the complex;
generating at least one signal representative of a Raman spectrum corresponding to the at least one SERS nanotag; and
comparing the Raman spectrum with a plurality of Raman spectra for known biological substances stored within the microprocessor to identify the biological substance.
